(19) United States
(12) Patent Application Publication
(10) Pub. No.: US 2015/0251486 A1
(43) Pub. Date: Sep. 10, 2015

(54) METHOD FOR PRODUCING A DECORATED WALL OR FLOOR PANEL

(71) Applicant: AKZENTA PANEELE + PROFILE GMBH, Kaisersesch (DE)

(72) Inventor: Hans-Jurgen Hannig, Bergisch Gladbach (DE)

(73) Assignee: AKZENTA PANEELE + PROFILE GMBH, Kaisersesch (DE)

(21) Appl. No.: 14/431,235

(22) PCT Filed: Oct. 15, 2013
(86) PCT No.: PCT/EP2013/071512

§ 371 Date: Mar. 25, 2015

(30) Foreign Application Priority Data
Oct. 17, 2012 (EP) 12188817.6

(51) Int. Cl. B44C 5/04

(52) U.S. Cl. CPC B44C 5/04; B44C 5/0461; B44C 5/043

(57) ABSTRACT

A method for producing a decorated wall or floor panel by application of a decorative pattern which emulates a decorative template to at least one part region of a plate-shaped carrier. The decorative pattern emulates the decorative template in a three-dimensional way with respect to color and structure by successive application of a plurality of decorative layers with an at least partially different surface application on the basis of three-dimensional decorative pattern data. A wall or floor panel having a decor which emulates a decorative template three-dimensionally with respect to the color and texture on account of a plurality of decorative layers on the panel with at least partially different surface coverage.

The present invention relates to a method for producing a decorated wall or floor panel and a wall or floor panel produced according to such a method.

Decorated plates are known per se, wherein the term wall panel also includes panels which are suitable as a ceiling lining. They normally consist of a carrier or a core of a solid material such as a wood-based material, which on at least one side is provided with a decorative layer and a top layer and optionally with further layers, for example, a wearing layer disposed between the decorative and the top layers. The decorative layer is usually a printed paper which is impregnated with an aminoplast resin. The top layer and the remaining layers are usually made of an aminoplast resin, too.

From the document U.S. Pat. No. 6,888,147 B1 a process for producing a panel is known. In a method known from this document, a decor is applied onto a core, whereupon the decor is provided with a varnish layer. In order to achieve a texture of the surface the top varnish layer is only partially applied, for example on the basis of data obtained e.g. by a digital camera.

However, in certain application areas, and in particular if highly detailed decorative plates are required previously known panels possibly show an unsatisfactory decoration, in particular when the imitation of a natural material such as wood or natural stone is desired.

Thus, it is an object of the present invention to provide an improved method for producing decorated wall or floor panels.

This object is achieved by a method according to claim 1. With respect to the wall or floor panel the object is achieved by a panel according to claim 13.

Thus, the invention proposes a process for producing a decorated wall or floor panel comprising the steps of:
a) providing a plate-shaped carrier,
b) applying a decor simulating a decorative template onto at least a portion of the carrier,
   characterized in that the decor is applied such that it simulates the decorative template three-dimensionally template identical with respect to the color and the structure by consecutively applying a plurality of decorative layers with at least partially different surface coverages based on provided three-dimensional decor data.

It could be shown that by successively applying a plurality of decorative layers with at least partially different surface coverages based on three-dimensional decor data the disadvantages known from the prior art in terms of accuracy and detail of an imitation of an applied decor can be overcome.

The term “decorative wall or floor panel” or “decorative panel” in the sense of the invention in particular means wall, ceiling or floor panels comprising a decor applied onto a carrier plate. Decorative panels are used in a variety of ways both in the field of interior design of rooms and for decorative cladding of buildings, for example in exhibition stand construction. One of the most common uses of decorative panels is their use as a floor covering. Herein, the decorative panels often comprise a decor intended to replicate a natural material.

Examples of such replicated natural materials are wood species such as maple, oak, birch, cherry, ash, walnut, chestnut, wenge or even exotic woods such as Panga Panga, mahogany, bamboo and bubinga. In addition, often natural materials such as stone surfaces or ceramic surfaces are replicated.

Accordingly, a “decorative template” in the sense of the present invention in particular means such an original natural material or at least a surface of such a material which is to be imitated or emulated by the decor.

The term “three-dimensional decor data” in the sense of the present invention in particular means electronic data, which represent the decorative template based on its three-dimensional size, color, texture, etc. and thus allow a complete physical or spatial haptically and visually identical or at least substantially identical reproduction of the decorative template. The three-dimensional decor data can be determined or generated directly or synthetically from the decorative template and thus, for example, can be stored in a database for later access. Moreover, the three-dimensional decor data in particular can have a resolution which does not enable a human to recognize a difference with respect to the decorative template in particular by an optical or haptic comparison or only enables to recognize a difference to a desired limited extent.

The term “template identical” in the sense of the present invention means a highly detailed simulation or imitation of the decorative template by the applied decor. Here, an imitation in each spatial direction or three-dimensionally can be realized, wherein, however, minor deviations due to technical feasibility, such as deviations from the provided decor data or the decorative template should be covered by the term template identical. Moreover, in the sense of the present invention the term template identical should include not only a positive representation of the decorative template with respect to the color and/or texture, but also a corresponding negative representation.

Herein, the term “plate-shaped carrier” in the sense of the present invention can be understood as a wood-based material, a fiber material or a material comprising plastics that is formed in the shape of a plate and, thus, in particular can serve as a core or as a base layer of the panel to be manufactured. For example, the plate-shaped carrier can already impart or contribute to a suitable stability for the panel. The plate-shaped carrier can already define the shape and/or size of the panel to be produced. However, the plate-shaped carrier can also be provided as a large plate. A large plate in the sense of the invention in particular is a carrier whose dimensions several times exceed the dimensions of the final decorative panels, and which is cut during the course of the manufacturing process into a corresponding plurality of decorative panels, for example by sawing, laser or water jet cutting.

Wood-based materials in the sense of the invention in addition to solid wood materials are materials such as cross-laminated timber, glue-laminated timber, blockboard, veneered plywood, laminated veneer lumber, parallel strand lumber and bending plywood. In addition, wood-based materials in the sense of the invention are also chipboards such as pressboards, extruded boards, oriented structural boards (OSB) and laminated strand lumber as well as wood fiber materials such as wood fiber insulation boards (HFD), medium hard and hard fiberboards (MB, HFH) and in particular medium density fiberboards (MDF) and high density fiberboards (HDF). Even modern wood-based materials such as wood polymer materials (wood plastic composite, WPC), sandwich boards made of a lightweight core material such as foam, rigid foam or honeycomb paper and a layer of wood applied thereto, and minerally hardened, for example with cement, chipboards are wood-based materials in the sense of the invention. Moreover, cork represents a wood-based material in the sense of the invention.

In the sense of the invention the term fiber materials means materials such as paper and non-woven fabrics on the basis of plant, animal, mineral or even synthetic fibers as well as cardboards. Examples are fiber materials on the basis of plant fibers and, in addition to papers and non-woven fabrics made of cellulose fibers, boards made of biomass such as straw, maize straw, bamboo, leaves, algae extracts, hemp, cotton or oil palm fibers. Examples of animal fiber materials are keratin-based materials such as wool or horsehair. Examples of mineral fiber materials are mineral wool or glass wool.

Examples of thermoplastic plastic materials are polyvinyl chloride, polyolefines (such as polyethylene (PE), polypropylene (PP)), polyamides (PA), polyurethanes (PU), polystyrene (PS), acrylonitril butadiene styrene (ABS), polymethyl methacrylate (PMMA), polycarbonate (PC), polyethylene terephthalate (PET), polyether ether ketone (PEEK) or mixtures or co-polymerizates thereof. The plastic materials can include common fillers, such as calcium carbonate (chalk), aluminum oxide, silicagel, quartz powder, wood flour, gypsum. In addition they can be colored in a known way. In particular it can be provided that the carrier material comprises a flame inhibitor.

By means of the above-described method it is possible to imitate or simulate a decorative template in a particularly detailed and highly accurate manner in a three-dimensional shape. This is not only possible by imitating the two-dimensional shape of a pore or the like of a wood material, for example, with a uniform depth. Rather, also a different depth or depth distribution of the pore is possible, so that even in a three-dimensional manner not only a template-like but rather a template identical replica of the decorative template is possible by the decor. In other words, pores or other structural features of the decorative template can be imitated accurately and realistically not only with respect to their width or length but also with respect to their depth or depth distribution at different depths in a pore.

Herein, without further steps it is possible without any problems and with high precision to produce a surface texture matching with the decor image. A surface texture matching with the decor image means that the surface of the decorative panel has a haptically perceptible structure which with respect to its shape and pattern corresponds to the optic of the applied decor, in order to achieve a reproduction of a natural material as close to the original as possible even with respect to the haptic.

Herein, such a product or wall or floor panel is produced by applying the decor template identically with respect to color and texture, wherein a plurality of decorative layers with at least partially different surface coverages is consecutively applied on the basis of three-dimensional decor data. Thus, the decoration does not only include one layer such as a printed paper layer, but rather is composed of a plurality of layers, the decoration layers. These layers are consecutively applied one by one in order to form the decor. Since these layers at least partially have a mutually different surface coverage, i.e. not all of the decorative layers are applied with the same spatial dimensions, by means of their different spatial extensions a defined depth image or depth perception can be produced. This not only allows a two-dimensional imitation of structural features of a decorative template, but rather a three-dimensional and thus completely identical imitation of the decorative template is possible in a particularly simple manner.

Herein, in particular through the use of digital decor data a highly accurate formation of the decor and thus a highly accurate perceptive impression of the produced panel is possible. Through the provision of digital decor data textures with an extremely high resolution and thus highly detailed can be imitated. Moreover, the use of digital decor data in a particularly simple way allows to respond in an inexpensive and dynamical way to customer requirements because only novel or changed decor data have to be provided on the basis of which again a highly accurate imitated product can be produced.

Moreover, by means of the above-described method in addition to a positive image with respect to the color and/or texture it is also possible to apply a corresponding negative image of the decorative template. In detail, as is known, for example, from positive staining or negative staining of wood-based materials, by the use of digital data the color impression of a texture can be inverted, so that with respect to the color and in particular with respect to lighter and darker areas a negative is created. A similar effect, in addition to the color impression, is possible for the applied structure, too, such that also with respect to the structural design a negative can be realized. Such effects, too, can be integrated into a manufacturing process based on digital three-dimensional data without any problems and without lead-time or retrofitting.

Further, by means of the above-described method in a particularly advantageous manner a so-called heliochrome effect can be realized. This term in the sense of the present invention means in particular that the decor comprises areas of different gloss levels such as both matte and glossy areas which in particular can be disposed in different depths of surface structures. As a result an even more realistic image of the decor template can be realized.

From the foregoing it is apparent that by means of the above-described method compared to the prior art an improved reproduction of the decor template and thus a highly detailed product is possible.

According to one embodiment of the method the three-dimensional decor data can be provided by three-dimensionally scanning of the decorative template. In particular, the three-dimensional decor data can be provided by three-dimensionally scanning the decorative template by means of electromagnetic radiation, for example by a three-dimensional scanner (3D scanner). By means of such a method for providing the three-dimensional decor data the decorative template can be used at any time to provide the corresponding data and produce a panel. This can in particular be advantageous for a fast and dynamic switching of the production. Moreover, the decor data can be obtained even three-dimensionally, i.e. in each spatial direction, with a particularly high resolution of e.g. 1000 dpi or even more and used for producing the panel. This allows for particularly high-quality details, which allows for a particular highly accurate optical and haptic emulation of the decorative template even three-dimensionally. Herein, the three-dimensional data can also generated without damaging the template so that they can be used basically for an unlimited number of scanning processes and can deliver unadulterated data.

In this case, a three-dimensional scanning, such as by a three-dimensional scanner, can preferably be carried out with respect to a plurality of angles. For example, scanning under five different angles can be implemented. In particular, an angle of x can be used as the base value which can be around 90°. This corresponds to scanning with a beam perpendicular to the surface of the decorative template. In addition, further scanning steps may be conducted, each using an angle that can be in a range of, for example x−30° to x+30°, i.e. for example in a range from 60° to 120° with respect to the surface of the decorative template. For example, additional scanning processes can be conducted at angles of x−15°, x−10°, x+10° and x+15°. At x=90° thus a scanning process can be carried out at angles of 75°, 80°, 90°, 100° and 105°, with respect to the surface of the decorative template.

According to a further embodiment of the method the decorative layers may be formed of a particularly radiation curable paint and/or ink. For example, a UV-curable paint or ink can be used. In this embodiment a particular detailed and matching replica of the decorative template can be obtained. On the one side a highly accurate synchronous pore can be achieved in this way without providing further measures. Herein, a synchronous pore can in particular be a pore or another structure, which is spatially located exactly there where it is displayed optically by a haptic texture matching with the optical decor features. In this embodiment this is essentially automatically the case, because the structural design is created by the paint or ink. In addition, decorative templates, such as wood-based materials, often comprise a variation of the color impression not only along their width or length but also along their depth. Even this color impression or color gradient can be simulated particularly detailed in this embodiment, such that the overall appearance of the panel looks even more identical. Herein, a particularly rapid solidification can be achieved especially when the paint or ink used is radiation curable, whereby the plurality of layers may be applied rapidly in succession, such that the entire process can be realized within a reduced time and thus is particularly cost-efficient.

The term radiation curable paint in the sense of the invention means a composition containing a binder and/or a filler as well as color pigments and which induced by electromagnetic radiation of a suitable wavelength, such as UV radiation or electron beams, can be at least partially polymerized.

The term radiation curable ink in the sense of the invention means a composition essentially free of fillers and comprising color pigments, which induced by electromagnetic radiation of a suitable wavelength, such as UV radiation or electron beams, can be at least partially polymerized.

According to a further embodiment of the method the decorative layers can be applied by direct printing. The term “direct printing” in the sense of the invention means the application of a decor directly onto the carrier of a panel or onto an unprinted fiber material layer applied to the carrier. In contrast to the conventional methods in which a decorative layer previously printed with a desired decor is applied onto the carrier, in direct printing the decor is printed directly in the course of the panel manufacturing process. Here, different printing techniques such as flexographic printing, offset printing or screen printing may be used. In particular digital printing techniques such as inkjet processes or laser printing can be used. The abovementioned printing techniques are particularly sophisticated and in particular advantageously suited for a panel production in order to apply a detailed decor template identically. Herein, in the sense of the invention direct printing also includes the application of the decor by means of printing techniques onto a printable layer previously applied onto the carrier. Such a printable layer can e.g. be formed by a liquidly applied and subsequently cured primer layer or a previously applied printable foil, paper or non-woven fabric layer.

In particular a digital printing process can be suitable for the above-described method because the three-dimensional decor data can preferably be provided in an electronic or digital form. This can apply both to data stored in a data base and data determined in-situ by a three-dimensional scanner. Thus, the provided decor data can be used in particular directly by digital printing processes without further intermediate steps, so that the method in particular according to this embodiment can be applied with particular low effort and cost-efficiently. Moreover, by using digital printing processes it is possible to carry out each printing process individually, such that a particular wide range of applications and a dynamical adaptation to the desired product is possible.

According to a further embodiment of the method the decor can be applied onto at least a portion of a primer previously applied onto the carrier. Herein, as a primer a liquid radiation curable mixture based on a urethane or urethane acrylate, optionally with one or more of a photoinitiator, a reactive diluent, a UV stabilizer, a rheological agent such as a thickener, radical scavengers, leveling agents, antifoams or preservatives, pigment, and/or a dye can be used. For example, the urethane acrylate may be included in the primer composition in the form of reactive oligomers or prepolymers. The term “reactive oligomer” and “prepolymer” in the sense of the invention is a compound comprising urethane acrylate units which are able to react radiation-induced, optionally with addition of a reactive binder or a reactive diluent, into urethane polymer or urethane acrylate polymer. Herein, urethane acrylates in the sense of the invention are compounds which substantially are composed of one or more aliphatic structural elements and urethane groups. Aliphatic structural elements comprise both alkylene groups, preferably comprising 4 to 10 carbon (C) atoms and cycloalkylene groups preferably comprising 6 to 20 carbon atoms. Both the alkylene and the cycloalkylene groups may be mono- or polysubstituted with C₁-C₄ alkyl, in particular methyl and include one or more non-adjacent oxygen atoms. The aliphatic structural elements are optionally linked to each other via quaternary or tertiary carbon atoms, via urea groups, biuret, uretdione, allophanate, cyanurate, urethane, ester or amide groups or via ether oxygen or amine nitrogen. Furthermore, urethane acrylates in the sense of the invention can also include ethylenically unsaturated structural elements. These preferably include vinyl or allyl groups, which may be substituted with C₁-C₄ alkyl, in particular methyl and which, in particular, are derived from α,β-ethylenically unsaturated carboxylic acids and their amides. Particularly preferred ethylenically unsaturated structural units are acryloyl and methacryloyl groups such as acrylamido and methacrylamido and in particular acryloxy and methacryloxy. Radiation-curable in the sense of the invention means that the primer composition induced by electromagnetic radiation of a suitable wavelength, such as ultraviolet radiation or electron beams, can be at least partially polymerized.

The use of radiation curable primers based on urethane acrylates allows in a particularly advantageous manner an application of the decor immediately subsequent to the application and the radiation-induced curing of the primer layer, for example, by means of a digital printing technique. Herein, the primer layer provides for a good adhesion of the applied decor onto the carrier surface coated with the primer. Herein, urethane acrylates offer the advantage of good adhesion to both the carrier material and the decorative layer, i.e. the decor paint or ink. This inter alia resides in the polymerization reactions occurring in this type of polymers, in which on the one hand a radiation induced radical polymerization of the OH groups occurs and on the other hand post curing of the polymer via the NCO groups occurs. Thus, after the radiation induced curing immediately a tack-free and further processable surface is obtained, while the final properties of the primer layer are also influenced by the post-curing process based on the NCO groups and provide for a secure bond to the carrier material. In addition, the occurring post-curing process ensures that a sufficient layer stability is achieved even in less or non-exposed areas of the carrier. Thus the method according to the invention enables in particular also pre-textured carriers, i.e. carriers whose surface already have a three-dimensional structure, to be provided with a primer layer, thereby ensuring that the subsequently applied decor firmly adheres to the carrier.

In the method according to the invention the primer can be applied onto the carrier plate by means of rubber rollers, a pouring device, or by spraying. Preferably, the primer is applied in an amount between ≧1 g/m² and ≦100 g/m², preferably between ≧10 g/m² and ≦50 g/m², in particular between ≧20 g/m² and ≦40 g/m². Subsequently to the application of the primer onto the carrier surface an irradiation process by means of a radiation source of an appropriate wavelength is carried out.

According to a further embodiment of the method the decorative layers each can be applied in a thickness in the range of ≧5 μm to ≦10 μm. For example, the decorative layers can respectively be applied in a thickness in the range of 8 μm. In particular, in this embodiment and with such thicknesses of the individual decorative layers, respectively, by means of a particular thin configuration of the decorative layer und, thus, a highly precise variability of the surface coverage or the coverage of a layer by means of the respective applied decorative layer a particularly template identical impression of the decor or the panel can be achieved. Herein, all decorative layers to be applied can be in the abovementioned thickness range or those decorative layers can be in the abovementioned thickness range in whose area a highly precise texture of the decorative template or the three-dimensional decor data are specified. Others than the abovementioned decor layers can e.g. be applied as thicker individual layers if here a highly precise texture is not specified by the decor template. Thus, the thickness of the applied decorative layers can substantially be adapted to the decorative template and be adjusted by means of the three-dimensional data. From the foregoing it is obvious, that even in this embodiment a direct printing process can be particularly advantageous in order to be able to adapt the method to the corresponding concrete application such as in particular to the decorative template or the desired product.

According to a further embodiment of the method the method can comprise the further process step
c) application of a wearing and/or top layer onto the decor.

Herein, it is particularly preferred, that for applying the wearing and/or top layer, too, a radiation curable composition, for example a radiation curable varnish such as an acrylic varnish, is applied. Herein, it may be provided that the wearing layer includes hard materials such as titanium nitride, titanium carbide, silicon nitride, silicon carbide, boron carbide, tungsten carbide, tantalum carbide, alumina (corundum), zirconia or mixtures thereof, in order to increase the wear resistance of the layer. Herein, the hard material can be included in the wearing layer composition in an amount between 5 wt.-% and 40 wt.-%, preferably between 15 wt.-% and 25 wt.-%. Herein, the hard material preferably has a mean grain diameter between 10 μm and 250 μm, more preferably between 10 μm and 100 μm. In this way in a preferable way it is achieved that the wearing layer composition forms a stable dispersion and a decomposition or precipitation of the hard material within the wearing layer composition can be avoided.

For forming a corresponding wearing layer in one embodiment of the invention it is provided that the radiation curable composition including the hard material is applied at a concentration between 10 g/m² and 250 g/m², preferably between 25 g/m² and 100 g/m². In this case, the application can be implemented, for example, by means of rollers such as rubber rollers, or by means of pouring devices.

Herein, it can be provided that the hard material is not included within the composition at the time of application of the wearing layer composition, but is scattered in the form of particles onto the applied wearing layer composition and subsequently the wearing layer is cured radiation induced.

A wearing and/or top layer is a layer applied as an outer border which in particular protects the decorative layer against wear or damage caused by dirt, moisture or mechanical impacts, such as abrasion.

According to a further embodiment the carrier can be provided on the basis of a natural material, a plastic material or a wood plastic composite (WPC) material. The material of the carrier plate can—depending on the desired physical properties of the finished plate—be massive dense or comprise more or less large cavities, for example be foamed or comprise cavities the size of which is in the order of the plate dimensions. Even laminate structures of several of said materials can be used, for example plasterboard or wood plastic laminate boards.

For example, the carrier plate can be formed from a thermoplastic, elastomeric or duroplastic plastic material. Even plates made of minerals such as natural and synthetic stone plates, concrete slabs, plaster fiber boards, so-called WPC boards (made from a mixture of plastic and wood) as well as plates made of natural raw materials such as cork and wood can be used as carriers according to the invention. Even plates made of biomass such as straw, maize straw, bamboo, leaves, algae extracts, hemp or oil palm fibers can be used according to the invention. Moreover, recycling materials from said materials can be used in the context of the method according to the invention. In addition, the plates can be configured based on the natural material cellulose such as paper or cardboard.

Preferred plate materials are thermoplastic plastic materials, such as polyvinyl chloride, polyolefins (for example polyethylene (PE), polypropylene (PP), polyamide (PA)), polyurethane (PU), polystyrene (PS), acrylonitrile-butadiene-styrene (ABS), polymethyl methacrylate (PMMA), polycarbonate (PC), polyethylene terephthalate (PET), polyether ether ketone (PEEK) or mixtures or co-polymerizates thereof. The plastic materials can comprise common fillers such as calcium carbonate (chalk), aluminum oxide, silicagel, quartz powder, wood flour, gypsum. They also can be colored in a known manner. In particular, it can be provided that the plate material comprises a flame retardant.

In particular, thermoplastic plastic materials offer the advantage that the products made from them can be recycled in a very simple way. Recycling materials from other sources can be used, too. In this way a further possibility for a reduction of the manufacturing costs is provided.

According to a further embodiment the plate-shaped carrier can be treated with a device for reducing the electrostatic charge prior and/or during process step b).

By providing a device for reducing the electrostatic charge such as a device for discharging electrostatic charges from the carrier to be printed the occurrence of blurring in the course of the production process can be avoided. This is in particular suitable for printing processes for applying the decorative layers, because electrostatic charges which build up in the carriers to be printed in the course of the production process result in a deflection of paint or ink droplets on their way from the print head to the surface to be printed. Herein, it is assumed that the electrostatic field which builds up on the carriers deflects the paint or ink particles which are typically positively charged, such that these do not impinge on the intended point of the surface to be printed. The thus induced inaccuracy of the paint or ink application leads to a perceivable blurring of the printed image. Dependent on the production speed and the selected carrier material this effect occurs to a different degree such that it is assumed that the carrier dependent on the carrier material is charged electrostatically during the transport within the manufacturing plant and this charge is sufficient to induce the observed effect.

Herein the device for discharging electrostatic charges may at least be a roller, a brush or a lip of a conductive material having a conductivity ≧1.10³ Sm⁻¹, which electrically conductive contacts the carrier at least in the region of the printing mechanism and which is connected to an electrical ground potential. In this case, the electrical ground potential may be provided, for example, by a grounding.

For example, the carrier can be treated prior to the supply to a printing mechanism and/or during the printing process within the printing mechanism by means for changing the electrostatic charge of the carrier by initially electrostatically discharging the carrier and subsequently charging the carrier with a defined charge amount. Herein, the abovementioned steps, i.e. discharging and supplying a defined charge amount, can be implemented once prior to the printing process together or individually in a suitable way or several times, for example prior to the application of a plurality of decorative layers. This embodiment can offer the advantage that by adjusting a defined electrostatic charge of the carrier or in particular the carrier surface the undefined deflection of ink droplets by an unpredictable and undefined electrostatic charge can be avoided. Herein in a surprising way it has turned out that the printed image compared to a sole discharge of electrostatic charges can be improved even further. For example, a device for supplying electrostatic charges onto the carrier, such as a charging system, can comprise a charge generator for positive (+) or negative (−) polarity and can be connected to a power adapter or a power supply in order to apply a defined charge onto the carrier or the carrier surface.

According to one embodiment it is provided that the device for discharging electrostatic charges from the carrier and/or the device for supplying electrostatic charges to the carrier is configured as a bar comprising a surface which extends substantially parallel to a surface of the carrier and faces towards the carrier. In particular, this surface of the bar serving as an active charging or discharging surface can extend along the entire width of the carrier, i.e. substantially at an orientation perpendicular to the moving direction of the carrier, over the entire dimension of the carrier. Herein, a surface of the bar which extends substantially parallel to a surface of the carrier can mean that the bar at least in the electrostatically discharged or charged area substantially has a uniform distance to the carrier, e.g. with a deviation of ≦20%, in particular ≦10% such as ≦1%.

Such a bar can in particular be a member which is substantially configured rectangular and comprises two plane aligned surfaces, which surfaces are disposed towards the carrier and toward the opposite direction. For example, the device for discharging electrostatic charges from the carrier and/or the device for supplying electrostatic charges to the carrier can be configured as a face ground bar. In particular in this embodiment corona discharges can be avoided and local voltage spikes or charge variations can effectively be avoided such that a discharge and in particular an electrostatic charge can be realized particularly uniform and in a defined way by producing a highly uniform charge distribution, such that the printed image can be particularly defined and of high quality, too. Herein, an electrostatic charge can be realized by applying a defined voltage to the bar, wherein by means of the type and amount of the voltage the type and amount of the electrostatic charge can be affected and adjusted. Herein, by means of electrically conductive contacting the moving carrier by the bar an electrostatic charge can be improved. The same applies for an electrostatic discharge, wherein in this case, too, a discharge can be realized by applying a voltage or by connecting with an electric mass potential.

According to one embodiment of the method a discharge in a range of larger than or equal to 7 kV, in particular larger than or equal to 10 kV, such as in a range of larger than or equal to 7 kV to less than or equal to 15 kV, is carried out. Alternatively or in addition an electrostatic charge in a range larger than 0 kV to less than or equal to 15 kV, such as less than or equal to 10 kV, can be carried out independent from the type of charge. It has been shown in a surprising way, that in particular a discharge by a predetermined charge amount and/or a charge by a predetermined charge amount can result in a particular good printed image.

According to a further embodiment of the method it can be provided that at least sub-steps of the method are implemented in an inert gas atmosphere. In particular it can be provided that the process step of applying the decor or the plurality of decor layers is carried out in an inert gas atmosphere. Suitable inert gases are, for example, nitrogen, carbon dioxide, noble gases or mixtures thereof.

Moreover, the invention relates to a wall or floor panel comprising a plate-shaped carrier, optionally a primer and a decor emulating a decorative template, characterized in that the decor comprises a plurality of decorative layers with at least partially different surface coverages, wherein the decor emulates the decorative template three-dimensionally template identical with respect to the color and structure.

In one embodiment of the wall or floor panel the decorative layers are substantially, in particular entirely, made from a radiation curable paint or ink. Herein, each of the layers can have a thickness in the range of ≧5 μm to ≦10 μm. Depending on the number of the applied layers the decor and, thus, the total of all decorative layers can have a layer thickness between ≧50 μm to ≦1 mm, preferably between ≧100 μm to ≦800 μm.

In a further embodiment of the wall or floor panel the plate-shaped carrier can comprise a profile at least in an edge region and the decor can be applied on the profile, too. In profiling according to the invention it is provided, that by means of suitable machining tools at least in a part of the edges of the decorative panel a decorative and/or functional profile is produced. Herein, a functional profile means, for example, the production of a groove and/or tongue profile within an edge in order to allow decorative panels to be connected to each other by means of the produced profiles. A decorative profile in the sense of the invention, for example, is a chamfer formed at the edge region of the decorative panel, for example, in order to simulate a joint between two interconnected panels, such as for example in so-called wide planks.

By partially profiling the decorative panel not all profiles to be provided in the finished panel are produced, but only part of the profiles, while other profiles are produced in a subsequent step. Thus, it may be provided, for example, that the decorative profile to be provided in a panel, such as a chamfer, is produced in one step, while the functional profile, e.g. groove/tongue, is produced in a subsequent step.

By means of the application of the decor subsequently to the at least partially profiling of the carrier, for example, by means of the above-described methods, such as direct printing, abrasion or damage of the decor in the course of the profiling process can be avoided in an advantageous way. Thus, the decor also in the regions of the profile corresponds in detail to the desired imitation, for example, of a natural material.

In order to provide a particular detailed imitation even in the profiled regions the master used for the printing process can be distortion corrected in the region of the profile of the panel. Distortion correction in the sense of the invention means, for example, with respect to the exemplary case of application by means of a printing process, that the distortion of the printed image caused by the deviation of the profiling out of the surface plane of the carrier, for example, at a chamfer edge, is corrected by matching the master with the deviation. Herein, it may be provided, for example, that the correction of the distortion is implemented by matching the pixel spacing, the pixel size and/or the ink application amount depending on the intended edge profile of the finished decorative panel. Herein, in case of printing by means of digital printing the print head can be driven depending on the distortion to be corrected, such that the print head, for example, is deflected beyond the profiled region and the ink discharge is adapted to the profile.

Here, it is e.g. possible that prior to the application of the decorative layer of the carrier provided as a large plate, the joints (such as V-joints) to be provided in the final panel laminate, are milled into the carrier, on the thus profiled carrier at least the decorative layer is applied and subsequently the carrier is cut at least in the profiled areas. Herein, depending on the cutting method, such as sawing, laser or water jet cutting, it may be preferred that the required bleed allowance is taken into account in the produced profile.

According to a further embodiment of the method an additional profiling step can be carried out at least in a portion of the edges of the decorative panel substantially parallel to the surface of the panel. Hereby, for example, die functional profiles to be provided, such as groove and tongue, can be produced in the panel, whereby, for example, a mechanic locking, such as a hook lock, of individual panels with respect to each other is possible. In the case of providing the carrier as a large plate such an additional profiling step is preferably implemented after the separation into individual panels. If the carrier is already provided in the desired size of the individual panel, such an additional profiling step may also be implemented simultaneously with the formation of the other profiles, such as a chamfer.

On top of the decorative layer a top or wearing layer can be applied. Herein, it can be in particularly provided, that the top or wearing layer is formed from a radiation curable varnish. The top or wearing layer can, for example, have a layer thickness between ≧100 μm and ≦5 mm, preferably between ≧0.5 mm and ≦2.5 mm. Likewise it can be provided, that the wearing and/or top layer is laid onto the printed carrier as a prefabricated overlay layer, such as based on melamine, and is bonded thereto by means of pressure and/or heat.

The invention is explained in detail below with reference to the figures and an exemplary embodiment.

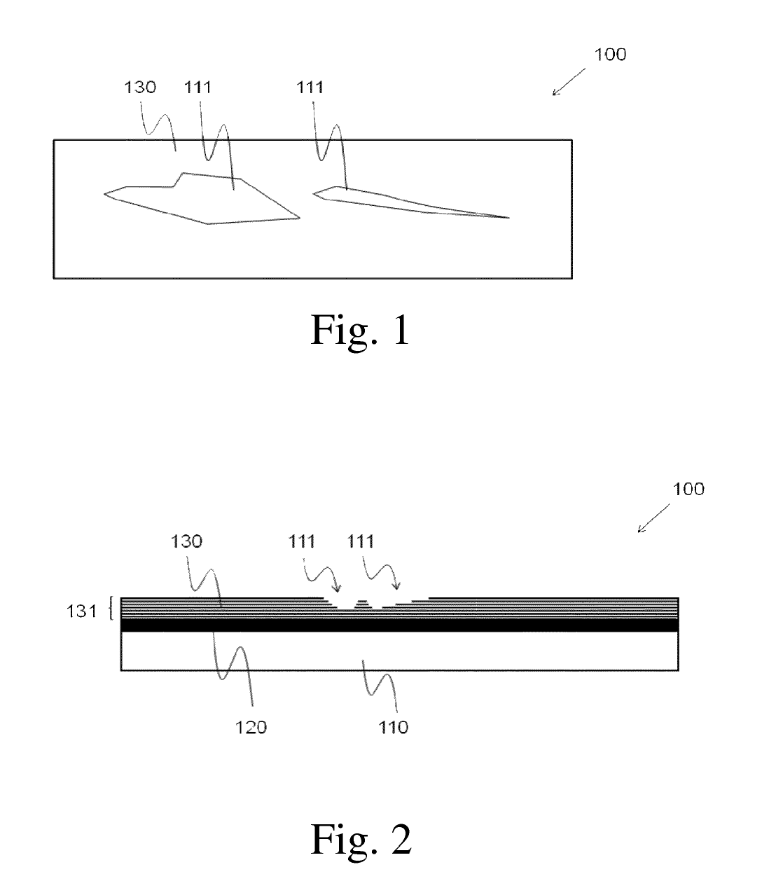

FIG. 1 shows schematically a top view of a wall or floor panel according to the invention; and

FIG. 2 shows schematically a cross sectional side view of the wall or floor panel of FIG. 1.

FIGS. 1 and 2 show a schematic structure of one embodiment of a wall or floor panel 100 according to the invention. The panel 100 comprises a plate-shaped carrier 110. The carrier 110 comprises or consists of e.g. a material based on a natural material, a plastic material or a wood plastic composite (WPC) material. For example, the carrier 110 is produced from an extruded plastic material such as polyethylene (PE), polypropylene (PP), polyamide (PA), polyurethane (PU), polystyrene (PS), acrylonitrile-butadiene-styrene (ABS), polymethyl methacrylate (PMMA), polycarbonate (PC), polyethylene terephthalate (PET), polyether ether ketone (PEEK) or mixtures or co-polymerizates thereof.

On top of the carrier 110 a decor 130 is applied which should imitate a decorative template. The decor 130 is applied by means of suited printing methods such as screen printing, digital printing, flexographic printing or offset printing. Moreover, on top of the plate-shaped carrier 110 prior to the application of the decor 130 a layer comprising a primer 120 is applied, which in particular comprises a radiation curable polyurethane acrylate or polyurethane.

Into the decor 130, for example, surface textures 111 replicating a natural wood-based material are introduced based on provided three-dimensional decor data, for example, provided by three-dimensionally scanning the decorative template. In order to configure the surface textures 111 of the decorative template not only with respect to its width and length, but even with respect to its depth or depth distribution precisely and realistic and, thus, template identical, the decor 130 is applied with a plurality of decorative layers 131 with at least partially different surface coverages, which with respect to the decorative template are textured template identical, or wherein the decor 130 emulates the decorative template three-dimensionally with respect to the color and structure. The decorative layers 131 are formed in particular of a radiation curable paint and/or ink and respectively have a thickness in the range from ≧5 μm to ≦10 μm.

For increasing the wear resistance a top layer and/or a wearing layer comprising a hard material can be applied onto the decor 130, wherein the top and/or wearing layer is in particular formed by a radiation curable varnish layer.

In addition, the wall or floor panel 100 or the plate-shaped carrier 110 can comprise a profile at least at an edge region and the decor 130 can be applied onto the profile, too.

1. Method for producing a decorated wall or floor panel, comprising the process steps of:
a) providing a plate-shaped carrier;
b) consecutively applying a plurality of decorative layers to the plate-shaped carrier;
wherein the consecutive layers have at least partially different surface coverage;
wherein the at least partially different surface coverages of the consecutive layers are based on three-dimensional decor data from a decorative template; and
wherein the plurality of layers form a decor which emulates the decorative template three-dimensionally with respect to color and structure.

2. Method according to claim 1, wherein the three-dimensional decor data are provided by three-dimensionally scanning the decorative template.

3. Method according to claim 2, wherein the decorative layers are formed from a particularly radiation curable paint and/or ink.

4. Method according to claim 2, wherein the decorative layers are applied by direct printing.

5. Method according to claim 2, wherein the decor is applied onto at least a portion of a previously applied primer.

6. Method according to claim 5, wherein as primer a liquid radiation curable mixture based on a urethane or a urethane acrylate is used.

7. Method according to claim 2, wherein the decorative layers are respectively applied in a thickness in a range of ≧5 μm to ≦10 μm.

8. Method according to claim 2, comprising the additional process step of
c) applying a wearing and/or top layer onto the decor.

9. Method according to claim 8, wherein a hard material containing radiation and/or heat curable varnish is applied as the wearing layer.

10. Method according to claim 2, wherein the carrier is provided based on a natural material, a plastic material or a wood plastic composite (WPC) material.

11. Method according to claim 10, wherein the carrier is provided based on a thermoplastic plastic material selected from the group consisting of polyvinyl chloride, polyolefines, polyamide (PA), polyurethane (PU), polystyrene (PS), acrylonitril butadiene styrene (ABS), polymethyl methacrylate (PMMA), polycarbonate (PC), polyethylene terephthalate (PET), polyether ether ketone (PEEK) or mixtures or co-polymerizates thereof.

12. Method according to claim 2, wherein the plate-shaped carrier is treated to reduce electrostatic charge prior and/or subsequently to process step b).

13. Wall or floor panel comprising a plate-shaped carrier, optionally a primer and a decor emulating a decorative template, characterized in that
the decor comprises a plurality of decorative layers with at least partially different surface coverage, wherein the decor emulates the decorative template three-dimensionally with respect to the color and texture.

14. Wall or floor panel according to claim 13, wherein the decorative layers are substantially formed from a radiation curable paint or ink layer.

15. Wall or floor panel according to claim 13, wherein the plate-shaped carrier at least in an edge region comprises a profile, and wherein the decor encompasses the carrier on a top surface and on the edge region profile.

16. Method of claim 1 wherein:
the three-dimensional decor data are provided by three-dimensionally scanning the decorative template;
a primer is applied to the carrier prior to application of the decorative layers;
the decorative layers are formed by direct printing of a radiation curable paint and/or ink;
wherein the decorative layers are applied in a thickness in a range of ≧5 μm to ≦10 μm; and
the plate-shaped carrier is treated to reduce electrostatic charge prior prior to step (b).
